(19) United States
(12) Patent Application Publication
(10) Pub. No.: US 2012/0310620 A1
(43) Pub. Date: Dec. 6, 2012

(54) METHOD AND SYSTEM FOR SIMULATION OF REAL-TIME SYSTEMS USING ACCESS POINTS

(75) Inventors: STEFAN RESMERITA, SALZBURG (AT); WOLFGANG PREE, SALZBURG (AT)

(73) Assignee: WOLFGANG PREE GMBH, SALZBURG (AT)

(21) Appl. No.: 13/484,553

(22) Filed: May 31, 2012

(30) Foreign Application Priority Data
May 31, 2011 (DE) 10 2011 076 821.1

(51) Int. Cl. G06F 17/50

(52) U.S. Cl. 703/17

(57) ABSTRACT

Computer-based simulation of a real time system which includes an application software to be executed on a target hardware platform (hardware and operating system). The application software has tasks of different priority and a set of instructions. An access point is defined for each task at an instruction representing an entry point of a task, a termination point of a task, an access to shared memory, an access to a register of the target hardware platform, and/or a system call or a driver function call, thus dividing the tasks into consecutive instruction blocks. A target execution time is assigned to each instruction block. A discrete event simulation is performed using a queue of events, each associated with a task, an access point of a task, and an event timestamp. During event processing, the instruction block corresponding to the access point associated with the event is executed without interruption.

### CROSS-REFERENCE TO RELATED APPLICATION

This application claims the priority, under 35 U.S.C. §119, of German patent application DE 10 2011 076 821.1, filed May 31, 2011; the prior application is herewith incorporated by reference in its entirety.

### BACKGROUND OF THE INVENTION

### Field of the Invention

The present invention relates to the field of simulating systems that have to meet strict real-time requirements (real-time systems), in particular to an improved software-in-the-loop (SIL) simulation method and system for simulating real-time systems.

Real-time systems are often employed in control systems to implement control laws for controlling technical processes. In many applications these real-time systems include distributed hardware, i.e. the software for the various tasks which are necessary for control purposes is executed on separated processors. Conventional systems for executing distributed software may include a plurality of nodes and a communication channel, wherein the system is configured such that the nodes are allowed to transmit data across the communication channel. Examples of such systems also include so called embedded systems in which the nodes which can also be referred to as electronic control units (abbreviated ECUs). An ECU may perform the tasks defined by software and may be encapsulated in the device which it controls. Examples of embedded systems include automotive systems, automation systems and avionics systems. An automotive system, for example, may in particular include a plurality of devices for operating brakes, a plurality of devices for sensing wheel speeds, a device for sensing the velocity of a vehicle etc. which communicate across a communication channel and which are configured to perform an operation of an anti-blocking system (ABS). Since the operation of an anti-blocking system is safety-critical to the vehicle and its passengers, it is required that repetitive readings of sensors, calculations and updating of actuators are performed periodically, for example, every five milliseconds. In practice, such a system has to fulfill strict real-time requirements, which means that correctness of a control operation depends not only on correctness of the control value to be actuated on the device under control, but also on the time at which the actuation is performed. An operation performed later than a “deadline” defined within the system is, by definition, incorrect, and usually has no value. That is, the control system has to guarantee the compliance with predefined timing requirements.

Conventional software designed for real-time systems is typically configured such that the software is separated into a plurality of tasks which the system has to perform. The tasks can be executed by one ECU (i.e. one node) or by different nodes, whereby each single node may execute one or more tasks. Some tasks may use output signals of sensors as their input, other tasks may provide output signals to actuators. Different tasks may communicate with each other by exchanging data. Such data exchange may include memory access to a shared memory by different tasks. A task schedule and the execution of tasks may depend on external events (e.g., external interrupts) which can be detected by the system by means of one or more sensors.

It is well known in the art that the development of embedded systems with hard real-time requirements is difficult, error-prone and thus expensive. This is true for single-node systems as well as for distributed embedded systems. For this reason simulation is essential in the development process of embedded systems. Different types of system simulators are known. A pure functional simulation neglects the fact that the tasks require an execution-specific time dependent on the hardware executing the task. Although such pure functional simulation is quick and inexpensive, it is in most cases useless or at least of reduced value for validating the design of real-time systems. In contrast, sophisticated hardware simulators (instruction set simulators, ISS) allow for detailed simulation of the software as well as the hardware. Instruction set simulators, however, are extremely slow and expensive.

### SUMMARY OF THE INVENTION

Thus, there is a need for an improved simulation method and a respective simulation system for simulating real-time systems. It is accordingly an object of the invention to provide a simulation method and device which overcome the above-mentioned disadvantages of the heretofore-known devices and methods of this general type and which provides for improved simulation that exhibits timing behavior as close to the execution platform behavior as possible, but is much faster than an instruction set simulator.

With the foregoing and other objects in view there is provided, in accordance with the invention, a method of a computer-based simulation of a real time system having an application software to be executed on a target hardware platform, the application software being composed of at least two tasks of different priority and each task having a set of instructions. The novel method comprises:

defining at least one access point for each task at an instruction representing at least one of the following:
an entry point of a task,
an termination point of a task,
an access to shared memory,
an access to a register of the target hardware platform,
a call to a function of the operating system or to a driver function provided by the target platform,

to thereby divide the tasks into instruction blocks;

assigning a target execution time to each of the instruction blocks representing a time required for executing the instruction block on the target system;

performing discrete event simulation using a queue of events, each of which being associated with a task, an access point of a task, and an event timestamp; and

during a processing of an event, executing the instruction block corresponding to the access point associated with the event without interruption.

In other words, we describe a method for simulating a real-time system. The real-time system comprises an application software to be executed on a target hardware platform, wherein the application software is composed of at least two tasks. Each task is composed of a set of instructions. In accordance with one example of the invention the method includes: defining at least one access point for each task at an instruction representing at least one of the following:
an entry point of a task,
a termination (exit) point of a task,
an access to shared memory,
an access to a register of the target hardware platform,
a call to a function of the operating system or to a driver function provided by the target platform,
   thus dividing the tasks into instruction blocks. The method further includes the assignment of a target execution time to each instruction block representing the time required for executing the instruction block on the target system, and a discrete event simulation using an event queue that includes, as events, the instruction blocks each associated with an event timestamp. A corresponding simulation system is disclosed, too.

Other features which are considered as characteristic for the invention are set forth in the appended claims.

Although the invention is illustrated and described herein as embodied in a method and device for simulating real-time systems using access points, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE INVENTION

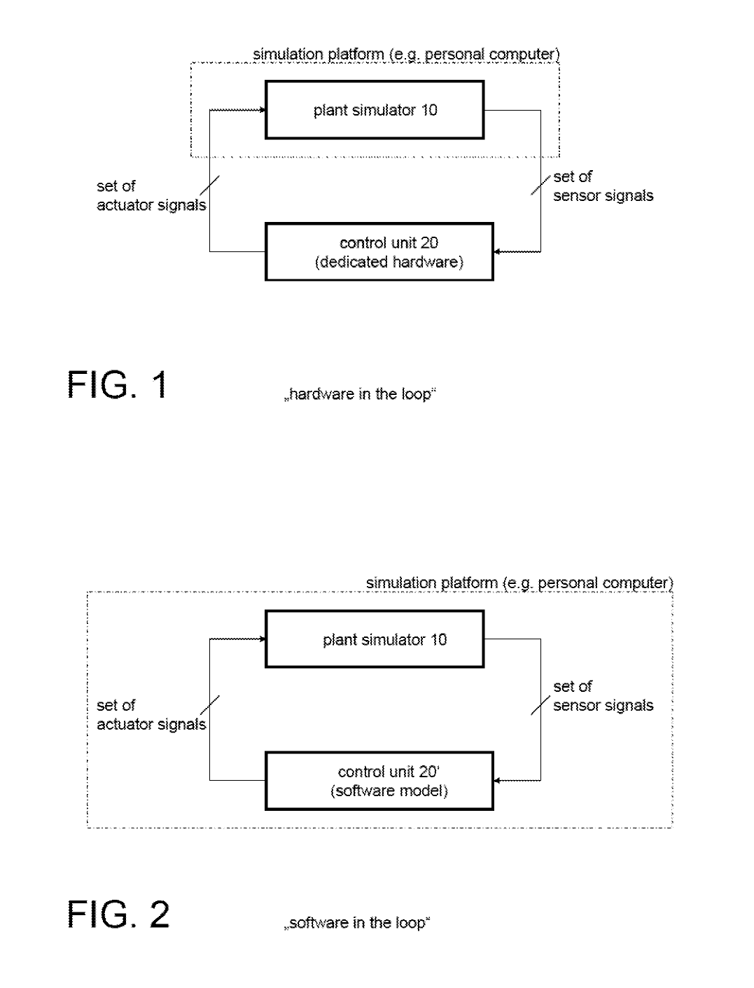

FIG. 1 illustrates the basic structure of a hardware-in-the-loop simulation;

FIG. 2 illustrates the basic structure of a software-in-the-loop simulation;

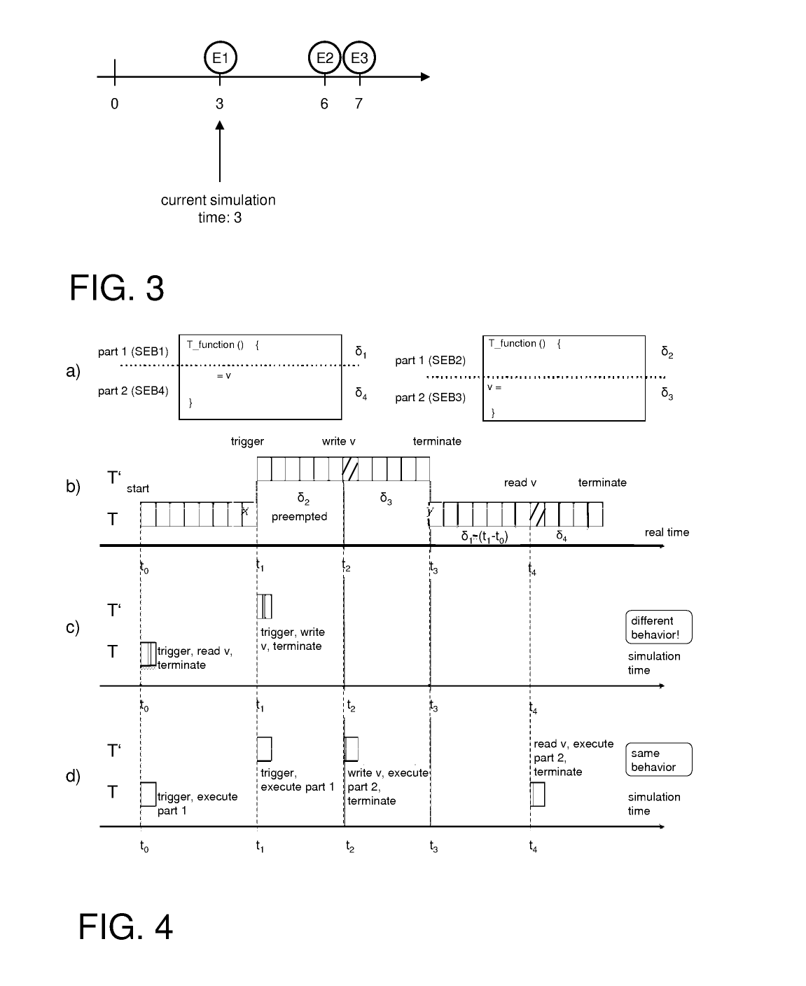

FIG. 3 illustrates the concept of the discrete event simulation;

FIG. 4 illustrates the task execution on the target platform and during the simulation using timing diagrams; and

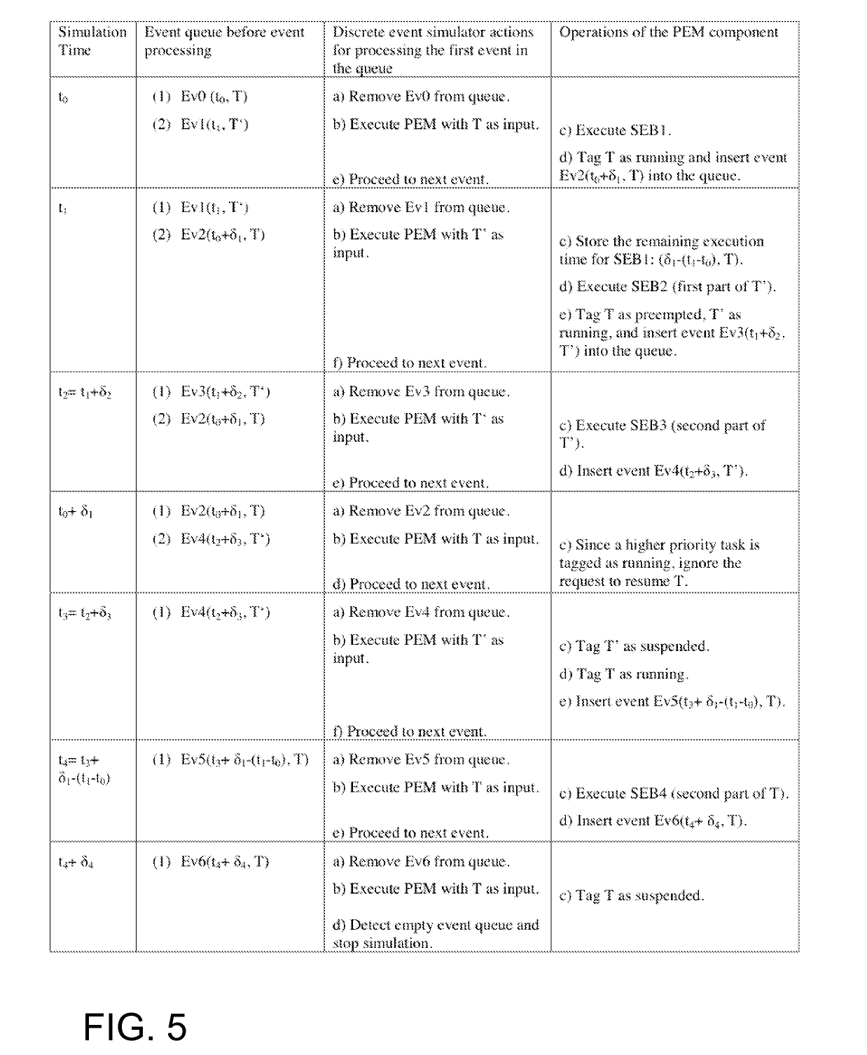

FIG. 5 illustrates the discrete event simulation, the content of the event queue and the corresponding time stamps according to one exemplary implementation of the present invention.

### DETAILED DESCRIPTION OF THE INVENTION

Real-time systems are typically found in automotive, rail, aerospace and military applications. Embedded software controlling such real-time systems usually includes a set of functions usually referred to as “tasks.” When executed, a task processes input values and delivers output values. In embedded software, some of the input values represent measurements of physical quantities (e.g., position, pressure, temperature, etc.) performed by sensors. Similarly, some of the output values represent desired quantities of physical properties (e.g., a desired position, desired temperature, desired voltage, etc.), which are imposed on the physical environment by actuators. Furthermore, task executions are triggered by sensors detecting discrete conditions in the physical environment. This includes periodic time-triggered tasks as well as sporadic event-triggered tasks. Real-time embedded systems are usually characterized by the fact that time plays a central role in the behavior of the system. In this case, the correctness of the system depends not only on the right transformation of input values to output values (which is a property of the software per se) but also on the correct points in time when the corresponding outputs are issued. This behavior is a property of the entire embedded system, which consists of the software and the target platform (hardware and operating system) executing the tasks. Such a computing system is called reactive because it always responds to stimuli from its environment.

An embedded system usually operates in a physical environment with which it interacts through sensors and actuators. An important class of real-time embedded systems therefore is represented by control systems. In this case, the embedded software is composed of a set of (controller) tasks and the physical system under control is referred to as the plant. In order to make the development process fast and inexpensive it is highly desirable to simulate embedded systems during the development process for validating the behavior of the embedded system without involving the real plant. Control engineers are often provided with a plant simulator (e.g., a MATLAB/Simulink model), which simulates the behavior of the plant as good as necessary by executing a software program on a personal computer or on a specialized real-time computer. An embedded system can be simulated in closed-loop with a plant model by hardware-in-the-loop (HIL) as well as by software-in-the-loop (SIL) methods.

Referring now to the figures of the drawing in detail and first, particularly, to FIG. 1 thereof, there is illustrated the general structure of a HIL simulation. The controller software is loaded into the target system which is generally a (e.g., embedded) computing system dedicated for particular types of control applications. This dedicated hardware, denoted as “control unit 20” in FIG. 1, executes the embedded software which determines the behavior of the control unit 20. The control unit 20 receives a set of sensor signals to be processed and provides a set of actuator signals (e.g., a desired motor current) supplied to a plant simulator 10 which emulates the plant to be controlled (e.g., a servo motor, a combustion engine, rudders of an aircraft, etc). The plant simulator 10 simulates the behavior of the real plant by providing appropriate sensor outputs (e.g., an angular position, a temperature value, etc.). As the embedded software is executed on the target hardware, the accuracy (quality) of the HIL simulation depends only on the accuracy (quality) of the plant simulation. Of course such a HIL simulation is also possible for single input and/or single output systems.

FIG. 2 illustrates the general structure of a SIL simulation. Usually, the plant simulation (plant simulator 10) as well as the embedded software (control unit 20′) are executed on the same hardware which may be, for example, a personal computer (host computer). As the embedded software is not executed on the target hardware, the accuracy (quality) of the SIL simulation does not only depend on the accuracy (quality) of the plant simulation but significantly on the detailedness of the simulation of the control unit 20.

The SIL simulation model of an embedded system includes the application software (embedded software) as well as an abstraction of the target platform (the embedded hardware including the operating system). The level of abstraction determines how close the software execution on the host computer is to the one on the HIL simulation (for the same plant model). SIL simulation models may range from a minimal representation of the target platform that essentially only allows for testing of functional (transformational or processing) properties of the software, to highly sophisticated hardware simulators (called instruction set simulators—ISS) which lead to system behavior close to the HIL simulation, while offering better observability of software executions (e.g., for debugging purposes). Pure functional simulations are fast, but do not allow for testing of timing properties of the embedded system. The ISS simulators are extremely slow and expensive.

A novel SIL simulation system and method include a simulation model that enables SIL simulations of embedded systems which are useful for testing real-time properties of the application without relying on detailed hardware simulation (as ISS do), thereby providing a fast simulation speed and, at the same time, significantly improved accuracy, close to the accuracy of HIL simulations.

Before going into the details of the novel simulation method and system, the properties of discrete event simulation and co-routines as well as the execution time estimation are briefly discussed. In discrete-event simulation, the operation of a system is represented as a chronological sequence of events. Each event occurs at an instant in time and marks a change of state in the system. The simulation must keep track of the current simulation time (in whatever measurement units are suitable for the system being modeled). In discrete-event simulations, as opposed to real time simulations, time “hops” because events are instantaneous. The clock skips to the next event time as the simulation proceeds. An event is associated to one or more functions of the simulated system that have to be executed when the event is processed. Furthermore, an event may contain data that is made available to these functions at the time of the event.

A discrete event simulator maintains a list of events ordered by their timestamps, called an event queue, and a simulation time, which is the timestamp of the event currently being processed. After processing an event, the simulator advances the simulation time to the timestamp of the next event in the queue and processes that event. New events can be added to the queue as a consequence of processing existing events or during the initialization phase of the simulation. The basic discrete-event operation is illustrated by an example shown in FIG. 3. In this example, the event queue contains three events E1, E2, and E3. The simulation “hops” from one event to the next. Assuming that event E1 is currently being processed, means that the simulation time is set to 3. After finishing the processing of E1 (and assuming that this does not introduce a new event with a timestamp smaller than 6), the simulator advances the simulation time to 6 and processes event E2. If the processing of E1 would insert a new event before E2, the simulation would hop to that new event and set the simulation clock accordingly.

Co-routines can be seen as a generalization of the concept of subroutines like procedures, methods, and functions. Co-routines are program components which allow multiple entry points for suspending and resuming execution at certain locations. The main difference between co-routines and subroutines is the fact that co-routines can interrupt their execution and resume execution later while maintaining their internal state. In order to understand this concept it is helpful to first discuss what an ordinary subroutine (i.e. a function in C or a method in Java) does, and then compare it to co-routines. The start of a subroutine is the only point of entry, and subroutines can return only once. In contrast, co-routines can return (in this case referred to as “yield”) several times. The start of a co-routine is the first point of entry. The next time the co-routine is called, the execution does not start at the beginning of the co-routine but just where the co-routine execution has previously been stopped.

A SIL simulation has also to deal with the estimation of the execution time of tasks and task fragments. Generally, the embedded software (i.e. the application software) is executed on a host computer, which is in general more powerful than the embedded target platform. Thus, the same code fragment is executed much faster on the host computer than on the target platform (i.e. the embedded system). To simulate the ongoing execution time that would pass if the code fragment would be executed on the target platform, the code fragment is annotated with the period of time which is necessary to execute the code fragment on the target platform; we refer to this as target execution time. This annotation takes place before the system is simulated. Note that, the basic blocks of the source code are annotated.

The code in a basic block has one entry point (meaning no line of code within the basic block is the destination of a jump instruction anywhere in the program) and it has one exit point (meaning only the last instruction of the basic block can cause the program to begin executing code in a different basic block). Under these circumstances, whenever the first instruction in a basic block is executed, the rest of the instructions are necessarily executed exactly once in order.

The execution time of a piece of source code highly depends on the platform (processor clock rate, pipelining, caching, scheduling by the operating system, etc.). There are basically two approaches to estimate the execution time: (1) static (object) code analysis and (2) measurement of code execution time on the target. Lots of research has been conducted for both approaches. The first approach often requires a detailed model of the platform (processor, cache sizes, scheduling concepts of the operating system, etc.). Such models are tedious to describe and often not available at all. For example, Intel does not publish the architecture of its processors. The second approach suffers from its scalability: to measure the execution times of all code fragments (e.g., of all basic blocks) would require executing the basic code fragments, probably several times, to get a reasonable range of best, worst and average execution times.

The simulation model employed by the novel SIL simulation system and method described herein receives the execution times of code as input, no matter which approach and which tool is used. Of course, the precision of the simulation depends on the accuracy of the execution time estimates or measurements.

Code instrumentation (=annotation) refers to adding special code (referred to as instrumentation) to the original application code composing the embedded software. The purpose of the instrumentation may be to pause and/or resume code execution at specified points in the code and to associate execution times with the code fragments between these points.

Examples of the present invention combine the above techniques of code annotation and discrete event simulation and usefully employ these in a novel SIL simulation model. Accordingly, a precise definition of the pause/resume points—which are henceforth referred to as “access points”—is provided to allow a respective code instrumentation. It is assumed that it is sufficient to simulate the task execution so as if switching between tasks (due to interrupts and preemptive scheduling) would occur at access points only. Co-routines may be employed to implement the simulation of task switching and interrupt handling. The above-mentioned assumption allows a quick and inexpensive SIL simulation of the embedded software and the target platform while, at the same time, achieving high accuracy comparable to HIL simulations. The behavior of the target platform is taken into account by instrumenting the application code with target execution times. Below, one example of a SIL simulation model is explained in more detail.

A “task” of the application software is either a general function that is called by the operating system or a function that is called when an interrupt occurs (i.e. an interrupt service routine). Memory that is accessed (in reading or writing) by different tasks is referred to as “shared memory”. Examples of shared memory are global variables accessed by different tasks. An “external register” is a register of a peripheral I/O device (input/output device) or a location of memory mapped to an I/O device. Examples of external registers are data and control registers of bus controllers, timers, analog-to-digital and digital-to-analog converters. An “access point” as mentioned above is a line of source code representing either
(a) the beginning of a task, i.e. the first line of program code of the unit,
(b) an end of a task, i.e., a return instruction from the task,
(c) an access (read or write) to shared memory,
(d) an access (read or write) to an external hardware register, or
(e) a call to a function of the operating system (often referred to as “system call”) or to a function of the target hardware platform (often referred to as a “driver function call”).

Access points (b) to (e) are referred to as “internal access points”. Generally, an internal access point is set at lines of source code which trigger an interaction with an information which is provided or required by external resources (memory, other tasks, peripheral interfaces, the operating system, etc.) A co-routine may be defined for every task. The co-routine is executed from the beginning whenever the task has to start a new execution, as determined by a simulated scheduler component of the operating system (for tasks) or by a simulated interrupt controller (for interrupt service routines). Every time a co-routine is called, the co-routine is executed from the beginning or resumed from a yield point (which coincides with an internal access point). The co-routine is called by a specialized component of the simulated system, called Program Execution Manager (PEM). The PEM controls a discrete event simulation with the following specific functionality: The PEM keeps track of the ongoing execution time for the executed application code and implements the processor reaction to interrupt requests, as detailed below.

In accordance with an example of the present invention, the application code (which is the source code of all tasks and interrupt service routines) is instrumented with a co-routine yield (return) instruction inserted immediately before every internal access point. Consequently, when executing the instrumented code, the execution control returns to the PEM right before each internal access point. The fragment of code executed between two successive access points is referred to as “synchronously executed block” (SEB). The PEM simulates the passage of the execution time corresponding to the SEB. Based on inputs from the (simulated) OS scheduler and the interrupt controller, the PEM is able to decide whether to continue with execution of the same task or whether it has to switch to another task which, for example, has a higher priority. The PEM resumes the execution of a task from the last yield point by simply calling (again) the corresponding co-routine. It should be noted that every SEB starts with an access point and it is executed without any intervention from other simulated components.

In order to take the target execution times into account, each basic block of the application source code may be annotated with the execution time on the target platform. Additional instrumentation may be employed to determine at runtime the execution times of the executed SEBs which might include several consecutive basic blocks with a particular control flow. However, for the present discussion it is sufficient to assume that, for each SEB, its target-specific execution time is available. At the end of each SEB, the control goes back to the PEM component, with the particular SEB's execution time as parameter.

The details of the program execution manager component, which controls the task execution during simulation and makes use of the above-mentioned discrete event simulation technique, are discussed in more detail below. Discrete event simulation is employed as a method to efficiently simulate the progress of time corresponding to code execution and interaction with the plant. In accordance with the principle of discrete event simulation the (simulated) time “hops” from event to event. The execution of code on a powerful computing platform such as a personal computer is typically much faster than the actual execution of the same code on a specific target platform (i.e. the embedded system). The events to be processed can be grouped in two categories:

(1) events related to the execution of the application software (the tasks) and

(2) events related to the simulation of the platform model.

An event in the first category is either an access point execution or the occurrence of an external interrupt. A correct processing of these events ensures that software execution in simulation is close to the real case. The events in the second category are generated by components of the target platform and are processed in (simulation time) order to simulate the behavior of the target platform as far it is considered to be relevant. Target platform events lead to the generation of interrupt events, which may trigger executions of application software and thus lead to an access point execution.

In accordance with an example of the present invention, the SIL simulation model provides a level of abstraction such that all lines of code in a SEB have the same execution timestamp, which is equal to the timestamp of the SEB's access point execution. This concept is illustrated by the example illustrated in FIG. 4a.

FIG. 4a sketches two task functions T and T′ which both access a global variable v, in reading and writing, respectively. The source code of the tasks is split as schematically shown in FIG. 4a. Therein, the time periods δ₁ to δ₄ denote the execution times (of a specific SEB of a specific task) on the target platform on which the corresponding SEBs should finally be executed. It should be noted that the time periods δ₁ to δ₄ typically have different values. The dotted line separating each of the tasks T and T′ into two segments illustrates an access point which is set immediately before the access of the global variable. Thus, each of the tasks T and T′ is composed of two SEBs, wherein a target execution time period (δ₁ to δ₄) is assigned to each SEB.

FIG. 4b illustrates, as an example, the execution of the two tasks T and T′ on the target platform: T is triggered at time t₀ and T′ is triggered at time t₁. As task T′ is assumed to have higher priority, it preempts the execution of the first part of the code of task T (assuming that t₁<t₀+δ₁). Thus, the value of the global variable v provided by T′ at time t₂ (t₂=t₁+δ₂) is read by the first task T at time t₄ (t₄=t₀+δ₁+δ₂+δ₃). The smaller boxes within the rectangles representing the tasks T and T′ schematically illustrate the execution of single lines of code in the source code of each task. Below, reference is made to source code lines x and y of task T. Another relevant position in the source code of both tasks is where the global variable v is accessed. This position is indicated by the hatched rectangles, where the value of the global variable v is stored in task T′ and the variable v is read in task T. It should be noted that the position in the source code (at the beginning of the second SEB of each task) and the corresponding time when that line of code is executed are independent as the scheduling of the tasks determines when a task is interrupted and when it resumes its execution.

FIG. 4c illustrates a pure functional (SIL) simulation of the two tasks on a host computer, where execution time is not considered at all. In this case, the entire task function is executed at the time when the task is triggered. Thus, variable v is first read by T and then updated by T′, which obviously differs from the behavior of the embedded software when executed on the target platform (see FIG. 4b). In the example of FIG. 4c task T′ changes the value after it was read by T. If the value written by T′ is different than the value the variable had at t₀, the observable behavior of T is potentially not the same in the (SIL) simulation and in reality (or HIL simulation).

The effect of the improved (SIL) simulation model as used in accordance with an example of the present invention is presented in FIG. 4d.

The simulation of the execution of the tasks T and T′ using discrete event simulation is illustrated in FIG. 5 whereby it is assumed that, initially, the event queue contains two events: an event Ev0 with timestamp t₀ for triggering task T (denoted as Ev0(t₀, T)), and an event Ev1 with timestamp t₁ for triggering task T′ (denoted as Ev1(t₁, T′). In this example, every event processing requires execution of the PEM component and each event has a data field which identifies the involved task (T or T′ in the present example). The discrete event simulator processes the first (earliest) event (here Ev0(t₀, T)) by setting the simulation time to t₀, putting the data field (here T) of the event into an input port of the PEM component, and executing the PEM component. The PEM starts the execution of task T by calling the corresponding co-routine. Accordingly, the SEB representing the first part of task T is executed as a whole (here SEB1), then the control returns to PEM (also providing the required target execution time δ₁ to the PEM). Then PEM registers a new event Ev2 in the queue with timestamp t₀-δ₁. Ev2 indicates a possible resumption time for the execution of T, more precisely for the future execution of SEB4. Also, PEM tags task T as running and stores the value δ₁ as the initial remaining execution time that needs to be consumed on the account of SEB1 of task T, before T can resume execution. The next events in the event queue are
(1) Ev1: the trigger for T′ with timestamp t₁ and
(2) Ev2: the execution of the SEB corresponding to the second part of task T with timestamp t₀+δ₁ (SEB4).

As, in the present example, t₁<t₀+δ₁, the earliest unprocessed event (1) is Ev1 which is thus processed next. Upon resuming discrete event execution the simulation time is set to t₁ and the PEM is called with T′ as parameter. The PEM updates the remaining execution time for the executed SEB1 of task T. The remaining time for SEB1 is thus δ₁−(t₁−t₀). Since, in the present example, task T′ preempts task T, the PEM stores the remaining time of SEB1 into an internal data structure and calls the co-routine of T′, leading to the execution of the SEB corresponding to the first part of task T′ (here SEB2) which returns before variable v is accessed and reports an execution time of δ₂ to the PEM. As a result, an event Ev3 for the execution of the second part (SEB3) of task T′ is inserted in the queue with timestamp t₂=t₁+δ₂, task T is tagged as preempted, task T′ is tagged as running, and the execution of PEM ends. At this point, the event queue contains the events Ev2 and Ev3. It is assumed, in the present example, that Ev3 is the earlier event (i.e., t₂<t₀+δ₁). Thus, the next event in the queue is the execution of the second part SEB3 of task T′. As a result of this processing, an event Ev4 is inserted into the queue with timestamp t₃=t₂+δ₃ representing the termination of the execution of T′.

Now, the events in the queue are Ev2 and Ev4. As, in the present example, Ev2 is the earlier event in the queue, i.e. t₀-δ₁<t₃, Ev2 is processed by executing PEM at simulation time t₀+δ₁ with a request to resume execution of T. The PEM detects that the currently running task T′ has higher priority and has not consumed its currently registered execution time (δ₃), so it ignores the request for T. Now, Ev4 is the only event in the queue, thus time is set to t₃ and PEM is executed. Since Ev4 is associated with an access point corresponding to an exit point of T′, PEM detects that T′ has terminated and tags T′ as suspended. Then PEM takes T as the highest priority preempted task and, as T still needs to consume a remaining execution time of δ₁−(t₁−t₀), PEM changes the tag of T from preempted to running and inserts an event Ev5 in the queue with timestamp t₄=t₃+δ₁−(t₁−t₀). This event is processed next, as it is the only one in the queue. At time t₄, PEM calls the co-routine of T, thus resuming execution from the access point onwards (i.e. SEB4). After SEB4 is executed, the control returns to PEM, which inserts the event Ev6 into the queue with timestamp t₄+δ₄, associated with the exit point of T, thus indicating the termination time of T. If no other triggering events are inserted in the queue until that time, the event queue becomes empty upon processing Ev6, and the simulation stops. Otherwise, the simulation would continue with the next event in the queue.

One can see that every access point is executed at the right time as compared to the execution timing when using the target hardware as illustrated in FIG. 4b. Thus, the simulation model as per the currently discussed example of the present invention preserves the order of accesses to the same shared resource from different tasks. FIG. 5 illustrates the above described simulation order of FIG. 4d using a table that includes the contents of the event queue during the simulation, the event processing actions performed by the discrete event simulator and the corresponding operations of the PEM component.

It should be noted that in the above example of FIG. 4d and FIG. 5 the order of execution of arbitrary lines of source code is not necessarily preserved. In the example of FIG. 4b the execution of task T′ takes place after executing line x of task T and before executing line y of task T. In the simulation model used in the example of FIGS. 4d and 5, the execution of task T′ takes places after the execution of the SEB corresponding to the entire first part of task T. In order to take into consideration the effects of preemption on data dependencies between concurrent components, it is sufficient to preempt executions only at access points. In other words, it does not matter at which line of code a preemption exactly occurs. The only relevant question is between which access points the preemption occurs. This observation allows for a fast simulation while preserving the relevant real-time behavior of the system.

The simulation model introduced above can be operated in closed-loop with plant models simulated by different tools, using variable step solvers. The novel simulation model also enables going across preemption points during forward and reverse debugging of the application. One can start a simulation from a previously saved state. Being implemented entirely in an imperative programming language such as the programming language C, the simulator may be easily interfaced/integrated with existing plant simulation tools (such as Matlab/Simulink).

Finally, some important aspects of the present invention may be summarized as follows, with the understanding, however, that this summary not to be understood as complete. The invention relates to method for computer-based simulation of a real time system. Such a real time system includes an application software to be executed on a target hardware platform (hardware and operating system), and the application software is composed of at least two tasks of different priority and each task includes a set of instructions. In accordance with one aspect of the present invention the method includes the definition of at least one access point for each task at an instruction representing at least one of the following:
an entry point of a task,
an termination point of a task,
an access to shared memory,
an access to a register of the target hardware platform,
a call to a function of the operating system (system call) or to a driver function provided by the target platform (driver function call),
   thus dividing the tasks into consecutive instruction blocks (which are separated by internal access points). The method further includes the assignment of a target execution time to each instruction block representing the time required for executing the instruction block on the target system (target execution time). A discrete event simulation is performed using a queue of events, each of which being associated with a task, an access point of a task, and an event timestamp. During the processing of an event, the instruction block corresponding to the access point associated with the event is executed without interruption.

A new event associated with the next access point of the task may be added to the event queue with a timestamp which depends on the timestamp of the current event and the target execution time assigned to the executed instruction block. Furthermore, before the execution of the task associated with the event, the task with the highest priority to be executed at the event timestamp may be determined. If the determined task is the task associated with the currently processed event and if the associated access point is not an exit (termination) point (which would require suspending the execution of the task), the instruction block starting at the access point associated with the event may be executed without interruption. A new event may be added to the event queue whenever an external condition requires a new execution of a task or continuation of a previously suspended task execution. The new event to be added is associated with a timestamp corresponding to the required task execution start time (resulting from the external condition, e.g., an interrupt).

During the processing of a currently processed (i.e. simulated) event, the associated task may be tagged “running” when an instruction block of the task is executed. Alternatively, the associated task may be tagged “ready” if another task of higher priority exists which is tagged “running”. Alternatively, the associated task may be tagged “suspended” when its previous tag was running and the event is associated either with an exit (termination) point of the task or with an access point representing a system call (or driver function call) that requires the task to wait before proceeding with the execution.

Similarly, a task not associated with the currently processed event is tagged “preempted” if that task's tag has been running immediately before the event, and the task associated with the current event is tagged “running”. The remaining execution time required for the preempted instruction block may be stored for future usage. The information of the remaining time will be needed when a resume of the preempted task is to be simulated. Furthermore, a task not associated with the currently processed event may be tagged “running” when (1) the task's previous tag has been “preempted” or “ready”, (2) the task has highest execution priority among all the preempted or ready tasks, and (3) the task associated with the current event is tagged suspended.

A new event associated with the task (previously preempted and) currently tagged “running” is added to the event queue with a timestamp depending on the timestamp of the current event and on the stored remaining execution time of the task now tagged running.

Any embodiment of the present invention may include one some of the technical features summarized above. However, all embodiments share the general concept of access points as described above and the fragmentation of the tasks' code to instruction blocks at these access points, wherein the target platform behavior is simulated by assigning each instruction block with a target platform execution time. For simulation purposes one instruction block is consecutively executed without interruption. Generally, an internal access point is set at lines of a task's source code which trigger an interaction with an information which is provided or required by task-external resources (memory, other tasks, peripheral interfaces, the operating system, etc.)

Although the present invention and its advantages have been described in detail, it should be understood that various changes, substitutions, and alterations can be made herein without departing from the spirit and scope of the invention as defined by the appended claims.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of a computer-based simulation of a real time system having an application software to be executed on a target hardware platform, the application software being composed of at least two tasks of different priority and each task having a set of instructions; the method comprising:
defining at least one access point for each task at an instruction representing at least one of the following:
an entry point of a task,
an termination point of a task, an access to shared memory,
an access to a register of the target hardware platform,
a call to a function of the operating system or to a driver function provided by the target platform,
thus dividing the tasks into instruction blocks;
assigning a target execution time to each of the instruction blocks representing a time required for executing the instruction block on the target system;
performing discrete event simulation using a queue of events, each of which being associated with a task, an access point of a task, and an event timestamp; and
during a processing of an event, executing the instruction block corresponding to the access point associated with the event without interruption.

2. The method according to claim 1, which comprises:
during the processing of an event, adding a new event associated with a next access point of the task to the event queue with a timestamp that depends on a timestamp of the current event and a target execution time assigned to the executed instruction block.

3. The method according to claim 1, which comprises, prior to executing the task associated with the event:
determining the task having a highest priority to be executed at the event timestamp; and
if the determined task is the task associated with the event and if the associated access point is not an exit point requiring suspending the execution of the task, executing without interruption the instruction block starting at the access point associated with the event.

4. The method according to claim 1, which comprises adding a new event to the event queue whenever an external condition requires a new execution of a task or continuation of a previously suspended task execution, the event being associated with a timestamp corresponding to the required task execution start time.

5. The method according to claim 1, which comprises, during the processing of a current event:
tagging an associated task as “running” when an instruction block of the task is being executed; or
tagging the associated task as “ready” if another task of higher priority exists that is tagged as “running”; or
tagging the associated task as “suspended” if a previous tag was running and the event is associated either with an exit point of the task or with an access point representing a system call that requires the task to wait before proceeding with the execution.

6. The method according to claim 1, which comprises, during the processing of a current event:
tagging a task that is not associated with the event as “preempted” if the task was tagged “running” immediately before the event, and the task associated with the event is tagged “running.”

7. The method according to claim 6, which comprises storing a remaining execution time required for the preempted instruction block for future use.

8. The method of one of the claim 7, which comprises, during the processing of a current event:
tagging a task that is not associated with the event as “running” if a previous tag of the task was “preempted” or “ready,” the task has highest execution priority among all the preempted or ready tasks, and the task associated with the event is tagged “suspended.”

9. The method according to claim 8, which comprises adding a new event associated with the running task to the event queue with a timestamp depending on the timestamp of the current event and on the stored remaining execution time of the newly running task.

10. A computer program stored in non-transitory form on an information processing device, the computer program comprising instructions, upon execution by the information processing device, for carrying out the methods according to claim 1.

11. A computer-based system for simulation of a real time system having an application software to be executed on a target hardware platform,
the application software being composed of at least two tasks of different priority and each task having a set of instructions;
wherein at least one access point is defined for each task at an instruction representing at least one of the following:
an entry point of a task,
an termination point of a task,
an access to shared memory,
an access to a register of the target hardware platform,
a call to a function of the operating system or to a driver function provided by the target platform,
thus dividing the tasks into instruction blocks;
wherein a target execution time is assigned to each instruction block representing a time required for executing the instruction block on the target system;
the computer-based system comprising:
means for performing discrete event simulation using a queue of events, each of which is associated with a task, an access point of a task, and an event timestamp; and
wherein the system is configured, during the processing of an event, to:
execute the task associated with the event without interruption starting from the access point associated with the event; and
adding a new event associated with the next access point of the task to the event queue with a timestamp that depends on the timestamp of the current event and the target execution time assigned to the executed instruction block.
